(19) United States
(12) Patent Application Publication
(10) Pub. No.: US 2007/0008553 A1
(43) Pub. Date: Jan. 11, 2007

(54) Method and apparatus for controlling output timing of video data

(75) Inventor: Young-Jin Park, Bucheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/440,079

(22) Filed: May 25, 2006

(30) Foreign Application Priority Data
Jun. 27, 2005 (KR) 10-2005-55897

(51) Int. Cl. G06K 15/10

(52) U.S. Cl. 358/1.5

(57) ABSTRACT

A method and apparatus for controlling output timing of video data for image formation are provided. The method for controlling the output timing of the video data includes counting a generation time of a horizontal synchronization signal HSYNC; comparing the counted time to an average time of previously counted times; and controlling the output timing of the video data for image formation according to the comparison result. Therefore, when the generation of a horizontal synchronization signal is delayed or advanced due to various external factors, the output timing of video data can be adjusted by including errors of the horizontal synchronization signal in an offset value to set a margin on a printing paper.

### CROSS-REFERENCE TO RELATED PATENT APPLICATION

This application claims the benefit under 35 U.S.C. §119(a) of Korean Patent Application No. 10-2005-0055897, filed on Jun. 27, 2005, in the Korean Intellectual Property Office, the entire disclosure of which is hereby incorporated in its entirety by reference.

### BACKGROUND OF THE INVENTION

1. Field of the Invention

The present invention relates to a method and apparatus for outputting video data for image formation. More particularly, the present invention relates to a method and apparatus for controlling output timing of available video data according to generation timing of a horizontal synchronization signal.

2. Description of the Related Art

Conventionally, a margin on a printing paper is set when a predetermined time is counted from the time a horizontal synchronization signal HSYNC is generated. The horizontal synchronization signal HSYNC is generated by a sensor (for example, a photo detector) of a laser scanning unit (LSU). When the predetermined time elapses, available video data for image formation is generated and output.

Since the video data is output after the predetermined time elapses, HSYNC errors will have an adverse effect on the vertical alignment of a printed image. The HSYNC errors result in vertical misalignment. The HYSNC errors will have an adverse effect on the vertical alignment of the printed image if the generation of the horizontal synchronization signal HSYNC is delayed or advanced due to various factors, such as variation in optical power of laser diodes, among others:

FIG. 1 is a view illustrating mismatches in the vertical alignment of an output image when an error occurs in the generation of a horizontal synchronization signal HSYNC, according to a conventional technique. As illustrated in FIG. 1, if a horizontal synchronization signal HSYNC is not generated at constant time intervals, then output timing of video data will also not be generated at constant time intervals. For example, if a horizontal synchronization signal HSYNC is delayed by a time ΔT, output timing of video data is also delayed by the time ΔT, which causes mismatches in the vertical alignment of a printed vertical line (A). To prevent errors from being generated in a horizontal synchronization signal, another conventional technique of feeding back a beam signal emitted from a laser diode to a photo diode and controlling the quantity of light of the laser diode to be kept constant has been proposed. In this conventional technique, an error can be generated in the beam signal fed back, which makes it difficult to keep the emitted quantity of light constant.

Accordingly, there is a need for an improved system and method for controlling the output timing of video data according to generation and timing of a horizontal synchronization signal HSYNC.

### SUMMARY OF THE INVENTION

An aspect of an exemplary embodiment of the present invention provides a method and apparatus that controls the output timing of video data according to generation and timing of a horizontal synchronization signal.

According to an aspect of an exemplary embodiment of the present invention, a method is provided to control output timing of video data for image formation. A generation time of a horizontal synchronization signal HSYNC is counted. The counted time is compared to an average time of previously counted times and the output timing of the video data is controlled for image formation according to the comparison result.

According to an aspect of an exemplary embodiment of the present invention, an apparatus is provided to control output timing of video data for image formation. The apparatus comprises: a timing unit that counts a generation time of a horizontal synchronization signal HSYNC; a time information storage unit that stores the counted time and previously counted times; an average time calculator that averages the previously counted times and obtaining an average time; a time comparator that compares the counted time to the average time of the previously counted times; and an output controller that controls the output timing of the video data for image formation according to the comparison result.

### BRIEF DESCRIPTION OF THE DRAWINGS

The above and other features and advantages of certain exemplary embodiments of the present invention will be more apparent from the following description taken in conjunction with the accompanying drawings, in which:

FIG. 1 is a view illustrating mismatches in the vertical alignment of an output image when errors occur in the generation of a horizontal synchronization signal, according to a conventional technique;

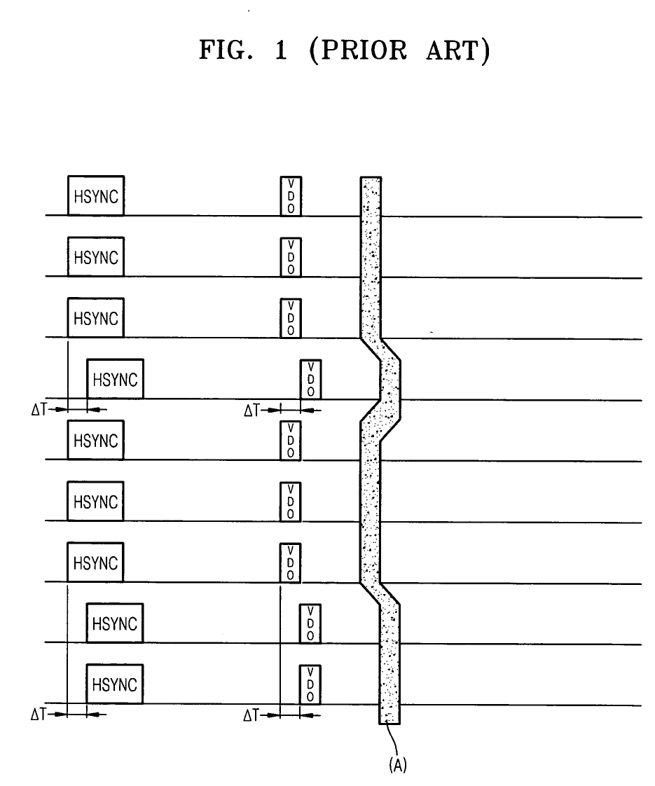

FIG. 2 is a flowchart illustrating a method of controlling output timing of video data according to an exemplary embodiment of the present invention;

FIG. 3 is a timing diagram illustrating an example in which output timing of video data is advanced by a delayed time of a horizontal synchronization signal according to an exemplary embodiment of the present invention;

FIG. 4 is a view illustrating an example in which an average time of eight previously counted times is compared to a currently counted time to adjust output timing of video data according to an exemplary embodiment of the present invention; and

FIG. 5 is a block diagram of an apparatus for controlling output timing of video data according to an exemplary embodiment of the present invention; and

FIG. 6 illustrates a time information storage unit illustrated in FIG. 5 according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

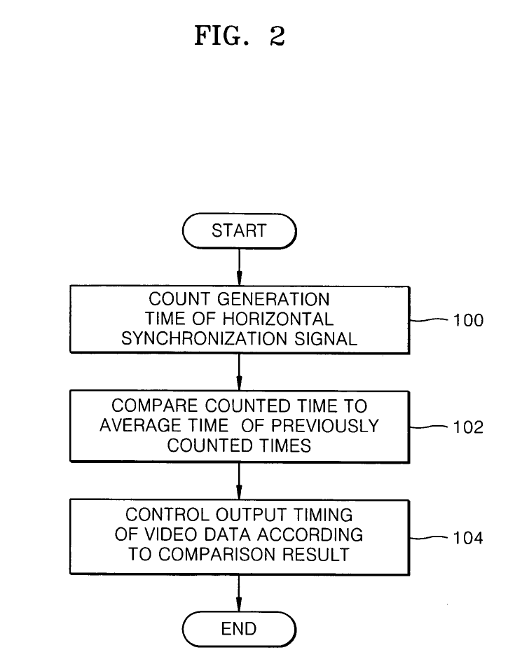

FIG. 2 is a flowchart illustrating a method of controlling output timing of video data according to an exemplary embodiment of the present invention.

First, a generation time of a horizontal synchronization signal HSYNC is counted (operation 100).

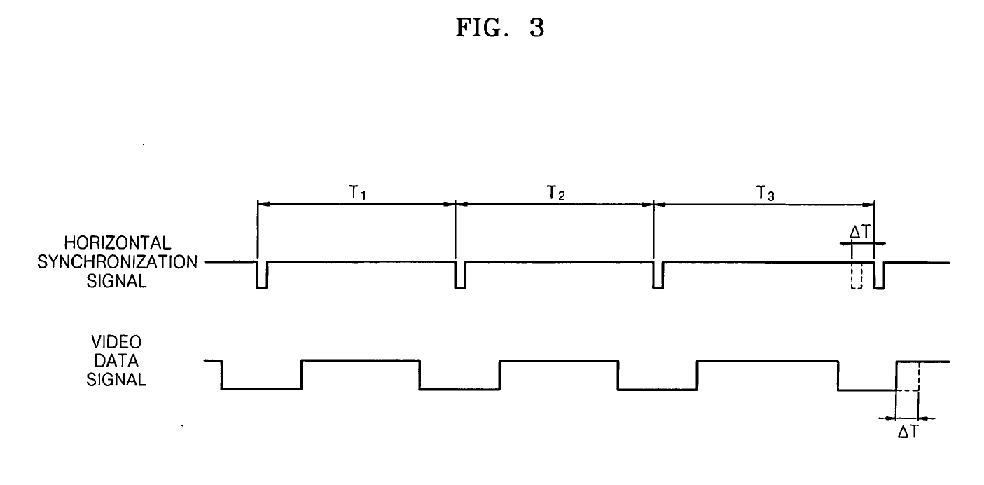

FIG. 3 is a timing diagram illustrating an example in which output timing of video data is advanced by a delayed time of a horizontal synchronization signal HSYNC.

Referring to FIG. 3, a generation time T₁, T₂, or T₃ of a horizontal synchronization signal HSYNC is counted.

After operation 100, the currently counted generation time T₁, T₂, or T₃ is compared to an average time of previously counted times (operation 102). As illustrated in FIG. 3, if a time counted in operation 100 is T₃, an average time of the previously counted times T₁, and T₂ is calculated and the currently counted time T₃ is compared to the average time.

Two, four, eight, or sixteen previously counted times may be averaged. The greater the number of previously counted times to be averaged, the higher the reliability for their average value.

The average time is a value obtained by averaging a predetermined number of latest counted times among a plurality of previously counted times.

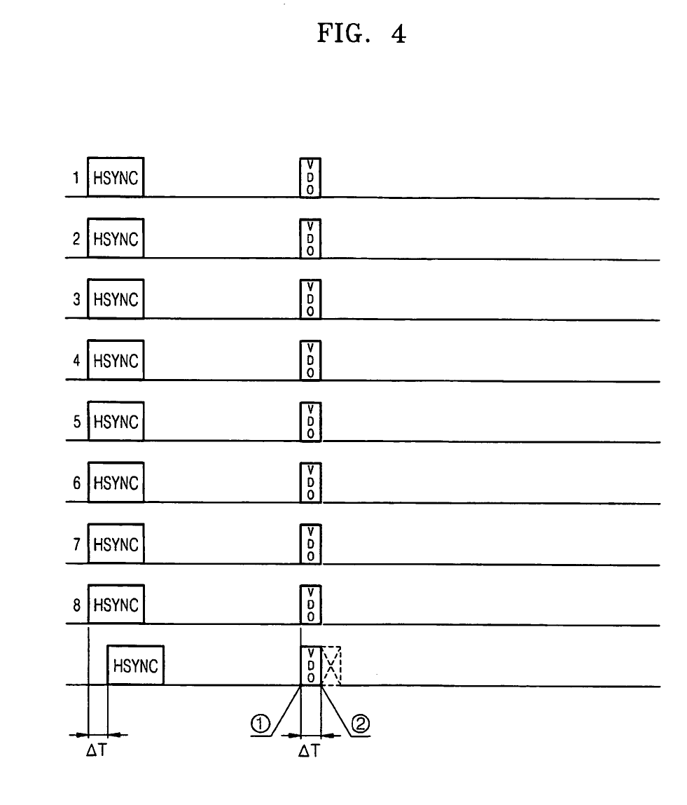

FIG. 4 is a view illustrating an example in which an average time of eight previously counted times is compared to a currently counted time to adjust output timing of video data. Referring to FIG. 4, the average time of the eight previously counted times is calculated and the average time is compared to the currently counted time.

After operation 102, output timing of video data for image formation is controlled according to the comparison result (operation 104).

If the currently counted time is greater than the average time, the output timing of the video data is advanced by a time difference between the currently counted time and the average time.

As illustrated in FIG. 3, the output timing of the video data is advanced by a time ΔT (a time difference between the currently counted time and the average time) when the currently counted time is T₃ and the currently counted time T₃ is greater by the time ΔT than the average time of the previously counted times T₁, and T₂. FIG. 4 illustrates video data output at output timing \textcircled{2} and delayed by a time ΔT from normal output timing \textcircled{1}. When a time difference ΔT exists between the currently counted time and the average time of the previously counted times, the output timing of the video data is automatically advanced by the time ΔT.

If the currently counted time is less than the average time, the output timing of the video data is delayed by a time difference between the currently counted time and the average time.

The output timing of video data is controlled by adjusting an offset value to set a margin on a printing paper. Two factors are considered for setting a margin on a printing paper. The first factor is the size of a predetermined dot stored in a margin register and the second factor is an offset value stored in a separate offset register. The sum of the size of the predetermined dot and the offset value is set as the margin. According to an exemplary embodiment of the present invention, the output timing of video data is controlled by adjusting the offset value.

Hereinafter, an apparatus for controlling output timing of video data according to an exemplary embodiment of the present invention will be described in detail with reference to the appended drawings.

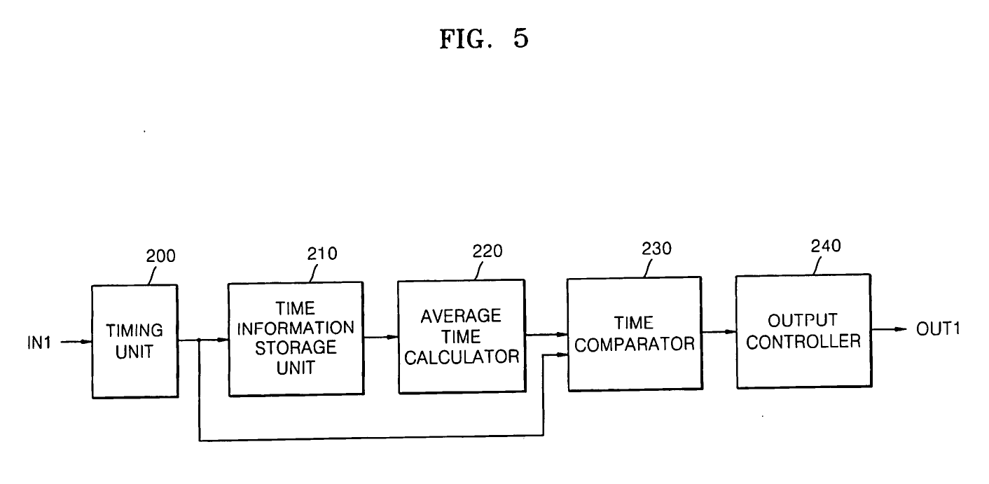

FIG. 5 is a block diagram of an apparatus for controlling output timing of video data according to an exemplary embodiment of the present invention. The apparatus comprises a timing unit 200, a time information storage unit 210, an average time calculator 220, a time comparator 230, and an output controller 240.

The timing unit 200 counts a generation time of a horizontal synchronization signal HSYNC and outputs the result to the time information storage unit 210 and to the time comparator 230. Referring to FIG. 3, the timing unit 200 counts a time T₁, T₂ or T₃ which is a generation time of the horizontal synchronization signal HSYNC. The timing unit 200 counts a time T₁, T₂ or T₃ whenever the horizontal synchronization signal HSYNC is generated.

The time information storage unit 210 stores the currently counted generation time and the previously counted times received from the timing unit 200.

The time information storage unit 210 stores a predetermined number of the latest stored counted times among a plurality of previously counted times.

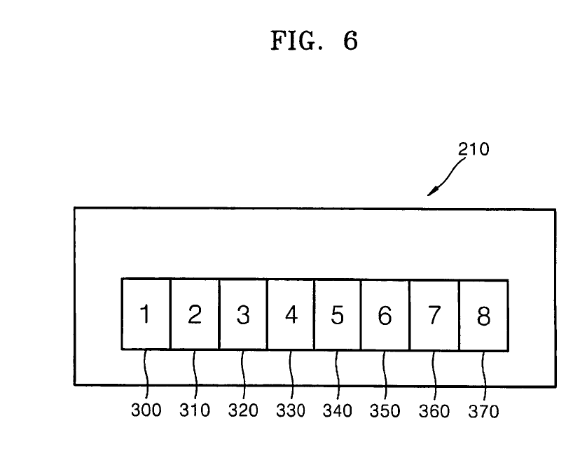

FIG. 6 illustrates an example of the time information storage unit 210 shown in FIG. 5 according to an exemplary embodiment of the present invention. Referring to FIG. 6, if a currently counted time is input to a first storage section 300, the time information storage unit 210 outputs eight previously stored times in the first through eighth storage sections 300, 310, 320, 330, 340, 350, 360, and 370, respectively to the average time calculator 220. The eight previously stored times in the first through eighth storage sections 300, 310, 320, 330, 340, 350, 360, and 370, respectively, move to neighboring storage sections. For example, time information stored in the first storage section 300 moves to the second storage section 310 and time information stored in the second storage section 310 moves to the third storage section 320. Also, time information stored in the third storage section 320 moves to the fourth storage section 330 and time information stored in the fourth storage section 330 moves to the fifth storage section 340. Additionally, time information stored in the fifth storage section 340 moves to the sixth storage section 350 and time information stored in the sixth storage section 350 moves to the seventh storage section 360. Further, time information stored in the seventh storage section 360 moves to the eighth storage section 370. Time information previously stored in the eighth storage section 370 is erased.

The average time calculator 220 calculates an average value of the previously counted times received from the time information storage unit 210 and outputs the average value to the time comparator 230.

The average time calculator 220 functions as a shift register. For example, if the average time calculator 220 receives eight previously counted times to be averaged from the time information storage unit 210, the average time calculator 220 shifts 3 bits of binary data obtained by summing the eight previously counted times and obtains an average value of the eight previously counted times.

The time comparator 230 compares the currently counted time received from the timing unit 200 to the average time of the previously counted times received from the average time calculator 220. The time comparator 230, then outputs the comparison result to the output controller 240. The time comparator 230 determines whether the currently counted time is equal to the average time. If the currently counted time is not equal to the average time, the time comparator 230 determines whether the currently counted time is greater or less than the average time.

The output controller 240 controls the output timing of video data for image formation according to the comparison result of the time comparator 230.

If the currently counted time is greater than the average time, the output controller 240 advances the output timing of the video data by a time difference between the currently counted time and the average time. FIG. 3 illustrates the advance of the output controller 240 and the video data signal output by the time difference ΔT. For example, if a currently counted time T₃ is greater by a time ΔT than an average time of the previously counted times T₁, and T₂, the output controller 240 advances and outputs the video data signal by the time difference ΔT.

Alternatively, if the currently counted time is less than the average time, the output controller 240 delays the output timing of the video data by the time difference ΔT.

The output controller 240 controls the output timing of the video data by adjusting an offset value to set a margin on a printing paper.

The method for controlling output timing of video data, according to an exemplary embodiment of the present invention, can also be embodied as computer readable code on a computer readable recording medium. The computer readable recording medium can be any data storage device that can store data capable of subsequently being read by a computer system. Examples of the computer readable recording medium comprises read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

In particular, the program for executing the panel driving method can be written in schematic language or Very high speed integrated circuit Hardware Description Language (VHDL) and can be executed by a programmable integrated circuit, such as a Field Programmable Gate Array (FPGA), among others. The recording medium comprises the programmable integrated circuit.

In a method and apparatus for controlling output timing of video data, according to an exemplary embodiment of the present invention, horizontal synchronization signal HSYNC errors reflected in an offset value can be used to set a margin on a printing paper. Thus, the output timing of the video data can be adjusted when the generation of the horizontal synchronization signal HSYNC is delayed or advanced due to various factors, such as a variation in optical power of laser diodes, among others. Also, a vertical axis alignment of the corresponding output image can be maintained when errors are generated in the horizontal synchronization signal HSYNC.

While the present invention has been shown and described with reference to certain exemplary embodiments thereof, it will be understood by those of ordinary skill in the art that various changes in form and details may be made therein without departing from the spirit and scope of the present invention as defined by the following claims.

What is claimed is:

1. A method of controlling output timing of video data for image formation comprising:
counting a generation time of a horizontal synchronization signal HSYNC;
comparing the counted time to an average time of previously counted times; and
controlling the output timing of video data for image formation according to the comparison result.

2. The method of claim 1, wherein the controlling of the output timing of the video data comprises:
advancing the output timing of the video data by a time difference between the counted time and the average time when the counted time is greater than the average time.

3. The method of claim 1, wherein the controlling of the output timing of the video data comprises:
delaying the output timing of the video data by a time difference between the counted time and the average time when the counted time is less than the average time.

4. The method of claim 1, wherein the controlling of the output timing of the video data comprises:
controlling the output timing of the video data by adjusting an offset value to set a margin on a printing paper.

5. A computer-readable recording medium comprising a computer program embodied thereon for executing the method of claim 1.

6. An apparatus for controlling output timing of video data for image formation comprising:
a timing unit for counting a generation time of a horizontal synchronization signal HSYNC;
a time information storage unit for storing the counted time and previously counted times;
an average time calculator for averaging the previously counted times and obtaining an average time;
a time comparator for comparing the counted time to the average time of the previously counted times; and
an output controller for controlling the output timing of the video data for image formation according to the comparison result.

7. The apparatus of claim 6, wherein the time information storage unit stores a number of latest stored counted times among a plurality of previously counted times.

8. The apparatus of claim 6, wherein the average time calculator functions as a shift register.

9. The apparatus of claim 6, wherein the output controller advances the output timing of the video data by a time difference between the counted time and the average time when the counted time is greater than the average time.

10. The apparatus of claim 6, wherein the output controller delays the output timing of the video data by a time difference between the counted time and the average time when the counted time is less than the average time.

11. The apparatus of claim 6, wherein the output controller controls the output timing of the video data by adjusting an offset value to set a margin on a printing paper.
